(19) United States
(12) Patent Application Publication
(10) Pub. No.: US 2026/0278669 A1
(43) Pub. Date: Sep. 17, 2026

(54) Visual-to-Structured Data Mapping System for Two-Dimensional Product Representations

(71) Applicant: Dale Adrian Kort, Syracuse, UT (US)

(72) Inventor: Dale Adrian Kort, Syracuse, UT (US)

(21) Appl. No.: 19/651,896

(22) Filed: Apr. 20, 2026

Related U.S. Application Data
(63) Continuation of application No. 19/651,756, filed on Apr. 19, 2026.

(51) Int. Cl. G06Q 30/0601; G06T 7/10

(52) U.S. Cl. CPC G06Q 30/0643; G06T 7/10

(57) ABSTRACT

A computer-implemented system and method for generating structured product specification data from a two-dimensional (2D) product representation is disclosed. The system includes a mapping engine configured to define or recognize a plurality of addressable regions within a 2D digital image or vector drawing. In response to an assignment event associated with a selected region, the system resolves a functional category corresponding to the region and generates or updates structured product specification data linking asset metadata to the functional category in a product data repository. In certain embodiments, the system further propagates an assignment across multiple product colorway definitions according to one or more inheritance rules. In certain embodiments, the system maintains bidirectional synchronization between the 2D product representation and the structured product specification data.

### CROSS-REFERENCE TO RELATED APPLICATIONS

This application is a continuation of U.S. patent application Ser. No. 19/651,756, filed Apr. 19, 2026, the disclosure of which is incorporated herein by reference in its entirety.

### FIELD OF THE INVENTION

The present invention relates generally to computer-implemented systems for generating and managing structured product specification data. More particularly, the invention relates to systems and methods that associate spatially defined regions of a two-dimensional (2D) digital product representation with functional categories in a structured product data model, and that translate visual interactions with or automated analysis of such regions into machine-readable updates to a product data repository. In certain embodiments, the invention further relates to systems for propagating product specification data across a plurality of colorway definitions and for maintaining bidirectional synchronization between a 2D product representation and an associated structured product specification record.

### BRIEF SUMMARY OF THE INVENTION

The present disclosure provides a computer-implemented system and method for generating structured product specification data from a two-dimensional (2D) product representation. In certain embodiments, the system includes a mapping engine configured to associate a plurality of spatially defined, addressable regions of a 2D product representation with corresponding functional categories in a structured product data model. In response to an assignment event associated with a selected asset and a location within the 2D product representation, the system resolves a target addressable region corresponding to that location, identifies a functional product category associated with the resolved region, and generates or updates one or more structured product specification records in a product data repository by associating metadata of the selected asset with the identified functional category. In certain embodiments, this process is performed without requiring separate manual entry of the same data in a non-graphical interface.

In certain embodiments, the mapping engine comprises a parsing module, a spatial-region identification module, an association module, and a record-generation module, each as further described herein. In certain embodiments, the 2D product representation may be a vector-based file, a raster-based image, or a combination thereof. In certain embodiments, the assignment event may be generated by a user interaction, such as a drag-and-drop or pointer-based selection, or by an automated process, such as a computer-vision module or image-analysis module operating without manual user input.

In certain embodiments, the system propagates an assignment event across a plurality of colorway definitions according to one or more inheritance rules, thereby generating or updating a separate structured product specification record for each colorway. In certain embodiments, the system resolves asset metadata independently for each colorway, such that the same asset may be associated with different color attributes or product-specific variants depending on the colorway definition.

In certain embodiments, the system maintains bidirectional synchronization between the 2D product representation and the structured product data repository, such that a change to an addressable region of the 2D product representation causes a corresponding update to associated structured product specification records, and a change to the structured product specification records causes a corresponding update to one or more visual attributes associated with the 2D product representation.

The disclosure provides systems, methods, and non-transitory computer-readable media embodying the foregoing. The foregoing summary is not intended to limit the scope of the invention, which is defined by the claims.

### BRIEF DESCRIPTION OF THE DRAWINGS

FIG. 1 is a block diagram illustrating the overall system architecture (100), including the mapping engine (106) and its four sub-modules (108, 110, 112, 114), the graphical user interface (116), the asset library (120), the processor (102), the memory (104), and the product data repository (118).

FIG. 2 is a schematic illustration of an example two-dimensional (2D) product representation (200) comprising a plurality of addressable regions, including a body region (202), a collar region (204), a left sleeve region (206), a right sleeve region (207), and a pocket region (212).

FIG. 3 is a flowchart illustrating an example assignment event flow, comprising event detection (302), region resolution (304), context resolution (306), asset metadata extraction (308), structured record transformation (310), and repository synchronization (312).

FIG. 4 is a schematic diagram illustrating colorway propagation, comprising an assignment event (402) processed by an inheritance rule engine (404) and propagated across a plurality of colorway records (406, 408, 410) with per-colorway asset variant resolution (412).

FIG. 5 is a schematic diagram illustrating bidirectional synchronization (500) between the 2D product representation (502) and the product data repository (504), including a visual-to-data assignment path (506) and a data-to-visual update path (508).

### BACKGROUND OF THE INVENTION

### Background

Conventional product lifecycle management (PLM) systems and related product data systems typically require product specification information to be entered independently from a two-dimensional (2D) product drawing when a three-dimensional (3D) model is unavailable. For example, where a designer, engineer, or product developer works from a 2D raster image or vector drawing, materials, trim, placement information, color relationships, quantities, and related product specification data are generally entered manually through a tabular or form-based interface.

In such systems, the visual product representation and the underlying structured product data are not inherently linked. As a result, changes made to the visual drawing are not automatically reflected in the structured product specification record, and changes made to the structured product specification record are not automatically reflected in the visual drawing.

### The Problem

This separation between the 2D product representation and the underlying structured product data introduces inefficiencies and potential error conditions. In many workflows, the bill of materials (BOM) or other product specification data must be manually reconciled with the drawing. This manual reconciliation process increases the number of user actions required to create or revise a product specification and may result in inconsistencies between the drawing and the associated product data.

Such inconsistencies may lead to specification errors, rework, manufacturing delays, increased product development cycle time, and additional cost.

The present disclosure addresses these limitations as described herein.

### Visual-to-Structured Data Mapping Engine

In certain embodiments, the disclosed system includes a visual-to-structured data mapping engine configured to associate spatial regions of a 2D product representation with structured product specification fields. The mapping engine may receive a user interaction, automated input, or programmatic assignment associated with a location or region of the 2D product representation and convert that interaction into a machine-readable update to a product data repository.

The mapping engine may include one or more of:
(1) a parsing module,
(2) a spatial-region identification module,
(3) an association module, and
(4) a record-generation module.

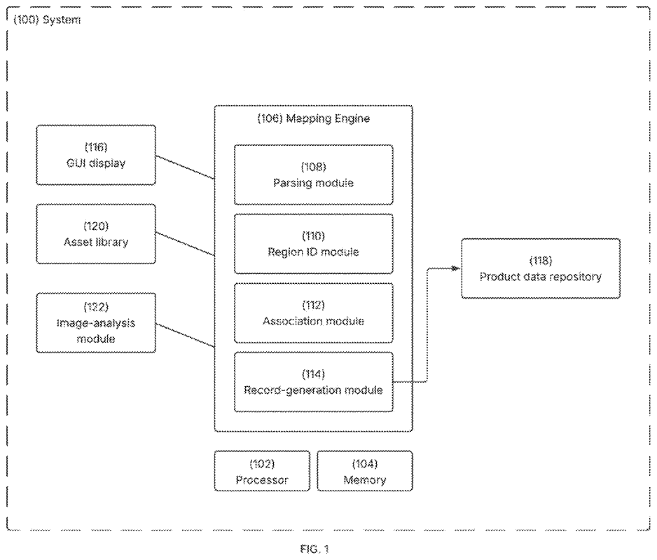

Each of these modules is described below. The overall system architecture is illustrated in FIG. 1.

### The Translation Engine Architecture

### Parsing Module

In certain embodiments, the mapping engine includes a parser configured to ingest a plurality of 2D file formats. The parser may process vector-based files, raster-based files, or both. For vector-based inputs, the parser may extract geometric boundary data associated with individual graphical objects. For raster-based inputs, the parser may access or generate region definitions based on coordinate groupings, masks, segmentation data, or other region metadata.

The parser may associate each extracted graphical object or region with an addressable identifier, thereby enabling later interaction with the object or region to be translated into a structured data operation.

### Spatial-Region Identification Module

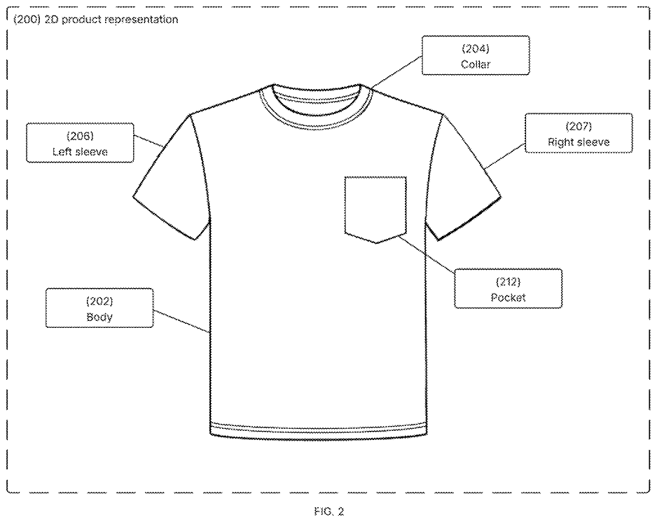

In certain embodiments, the system includes a spatial-region identification module configured to define or recognize one or more addressable regions within a 2D product representation (see FIG. 2 for an example of a 2D product representation (200) comprising a plurality of addressable regions).

For vector-based representations, the addressable regions may be defined by mathematically represented graphical elements, including but not limited to paths, polygons, layers, closed shapes, or grouped vector objects. Each such region may be associated with a unique geometric identifier.

For raster-based representations, the addressable regions may be defined by masks, coordinate ranges, pixel groupings, segmentation regions, heat maps, or other stored metadata structures that associate one or more image coordinates with a defined product zone. In some embodiments, the raster representation is accompanied by a hidden metadata layer defining a plurality of selectable regions.

### Association Module

In certain embodiments, the system includes an association module configured to associate an addressable spatial region with a functional category, component type, or structured repository field.

For example, a region corresponding to a collar portion of a garment drawing may be mapped to a collar-related component category within a bill of materials or structured product specification. Similarly, a region corresponding to a lining panel, cuff, pocket, trim, waistband, or other product portion may be mapped to a corresponding functional category.

The association may be defined through a lookup table, schema, relational mapping structure, or rule set. In some embodiments, the association structure is organization wide. In other embodiments, the association structure is style-specific, product-specific, or user-defined.

As a result, when a material asset or other product attribute is assigned to a particular region, the system can determine the corresponding category or field in the structured product data model.

### Record-Generation Module

In certain embodiments, the system includes a record-generation module configured to generate, update, or synchronize one or more structured product specification records based on an interaction with an addressable region.

Once the system determines (i) the selected asset or attribute and (ii) the spatial region to which the asset or attribute has been assigned, the record-generation module may perform one or more repository operations. Such operations may include retrieving an identifier associated with the selected asset, determining a corresponding target field or category in the structured product data model, and writing or updating one or more records in a product data repository.

In some embodiments, the record-generation module updates the structured product record without requiring the user to separately enter the same information in a non-graphical tabular interface.

### Example Assignment Event Flow

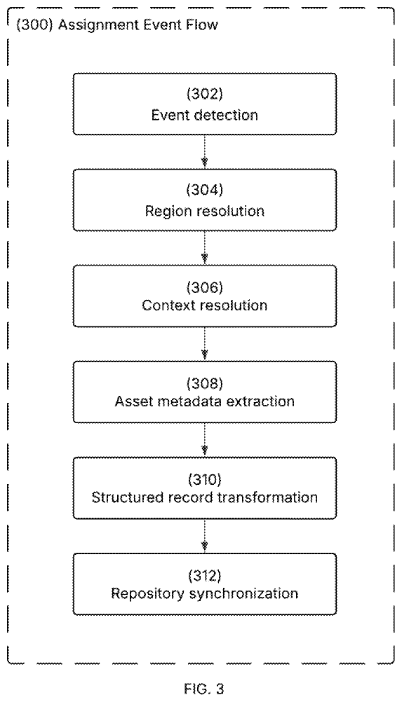

In one embodiment, the system performs the following operations in response to a detected assignment event (as illustrated in FIG. 3):

### 1. Event Detection

The system detects an assignment trigger associated with a location in the 2D product representation. The assignment trigger may be generated by a drag-and-drop event, pointer selection, touch interaction, stylus interaction, programmatic input, or other input event.

### 2. Region Resolution

The system performs a spatial analysis to determine which defined region corresponds to the detected location. The spatial analysis may include hit testing, intersection testing, coordinate comparison, mask lookup, or geometric boundary evaluation.

### 3. Context Resolution

The system identifies a functional category, component role, or structured field associated with the resolved region.

### 4. Asset Metadata Extraction

The system obtains metadata associated with the selected asset, such as a material identifier, trim identifier, color identifier, supplier identifier, or other structured attribute.

### 5. Structured Record Transformation

The system generates or updates structured product specification data by linking the asset metadata to the field, category, or component corresponding to the resolved region.

### 6. Repository Synchronization

The transformed data is transmitted to and stored in a product data repository.

### DETAILED DESCRIPTION OF EXAMPLE EMBODIMENTS

In one embodiment, the mapping engine comprises a spatially addressable translation layer in which a 2D product representation is partitioned into a plurality of defined regions. Upon detecting an interaction event associated with one or more coordinates of the 2D product representation, the system executes a spatial query to determine a corresponding region.

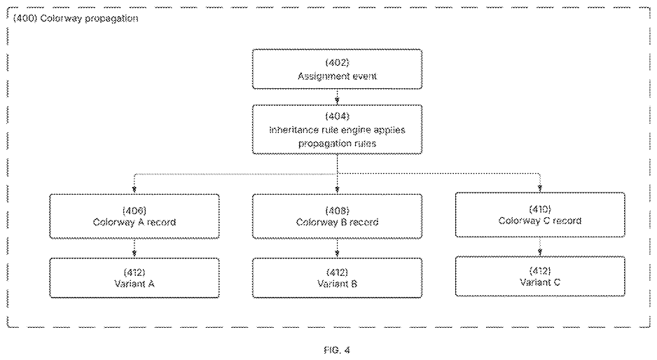

The system then references a mapping structure that associates the resolved region with a field, component category, or role in a structured product specification model. Based on this association, the system transforms the interaction event into machine-readable data compatible with a product data repository. In certain embodiments, the system further propagates this association across a plurality of colorway definitions via an inheritance rule engine, as illustrated in FIG. 4.

In certain embodiments, the product data repository may include a bill of materials, a product data management system, a product lifecycle management system, an enterprise resource planning system, a digital asset management system, or another structured repository configured to store product-related information.

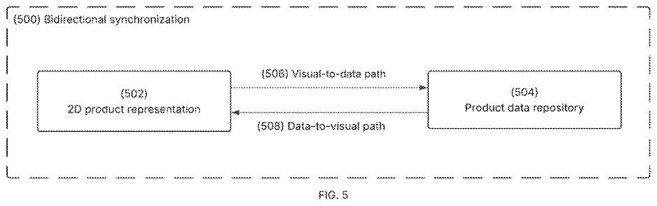

In certain embodiments, the disclosed system supports bidirectional synchronization between the graphical product representation and the structured product data (see FIG. 5). Thus, a change to a visual region may update structured product specification data, and a change to the structured product specification data may update one or more visual attributes associated with the region.

The disclosed methods are not limited to any particular software environment. In various embodiments, the methods may be implemented in a web-based application, native desktop application, mobile application, browser-based interface, or other graphical computing environment.

Likewise, the invention is not limited to any particular 2D format. In different embodiments, the system may operate on vector-based files, raster-based files, layered image structures, proprietary drawing formats, open-standard graphical formats, or other 2D representations having addressable or mappable regions.

### Technical Solution to a Technical Problem

The current invention provides a technical solution to the problem of data fragmentation in 2D design environments. Unlike 3D CAD systems which possess inherent data-awareness, 2D raster and vector files lack native relational links to manufacturing metadata. The present system bridges this gap via a specialized translation engine that converts spatial coordinates into structured product data records in a product data repository.

### Definitions

Product Data Repository: As used herein, this term refers to any non-transitory computer-readable storage architecture or environment configured to maintain and manage Structured Product Specification Data. This includes, without limitation, relational databases (SQL), document-oriented databases (NoSQL), graph databases, key-value stores, and object-oriented storage. The repository may be hosted locally, via a remote server, or as a cloud-based service, and is intended to encompass software categories including, but not limited to, Product Lifecycle Management (PLM), Product Data Management (PDM), Product Experience Management (PxM), Digital Asset Management (DAM), and Enterprise Resource Planning (ERP).

Assignment Trigger: As used herein, this term refers to a digital event, signal, or data packet that initiates the association of a specific material asset with a specific region of a 2D Representation. An assignment trigger may be generated by manual user interaction (e.g., a pointer-based drag-and-drop, a gesture, or a voice command) or by an automated machine process (e.g., a computer-vision module or an artificial intelligence agent identifying regions and assets via pattern recognition) without departing from the scope of the invention.

2D Representation: As used herein, this term refers to a digital two-dimensional graphical model of an article of manufacture. This includes raster-based imagery (e.g., pixel-mapped files such as PNG, JPG, or TIFF) and vector-based graphics (e.g., mathematically defined geometric primitives including paths and polygons, such as SVG, AI, or EPS). The representation may include technical flats, sketches, photographs, or rendered illustrations.

Translation Engine: As used herein, this term refers to the specialized computing logic—comprising software, hardware, or a combination thereof—configured to resolve the spatial coordinates of an Assignment Trigger into a functional category within the Structured Product Specification Data. The engine acts as the intermediary mapping layer that converts visual interactions or identifications into machine-readable database commands.

### Automated and Assisted Embodiments

Although certain embodiments described herein involve pointer-based user interaction, the disclosed system is not limited to manually initiated assignment events.

In certain embodiments, an assignment trigger may be generated by an automated or assisted process, including but not limited to a computer-vision module, image-analysis module, machine-learning module, rules engine, or remote computing process. Such a module may identify candidate regions within a 2D product representation and may automatically propose, generate, or apply an association between an asset and a functional category.

In an example automated embodiment, the system includes an image-analysis module configured to identify one or more regions in a 2D representation based on visual features, geometric boundaries, segmentation data, layer analysis, or pixel-mask analysis. The system may then apply the same translation logic used for user-generated interactions to generate corresponding structured product specification data.

In one example of a fully automated embodiment, the system receives a vector-based 2D product representation comprising a plurality of closed geometric paths. The image-analysis module analyzes the file's geometric structure and identifies five distinct closed boundary regions based on path enclosure, area, and relative position within the drawing. The module assigns each identified region an addressable identifier and submits each as a candidate region to the mapping engine.

The mapping engine references a stored region-to-category mapping and resolves each candidate region to a corresponding functional product category. In this example, the five regions are resolved to a collar category, a body category, a left sleeve category, a right sleeve category, and a pocket category, respectively. No user interaction is required to perform this resolution.

The system then retrieves, from an asset library, metadata associated with one or more assets that have been programmatically designated for automatic assignment—for example, a base fabric asset designated as the default material for body and sleeve regions. For each resolved region designated for automated assignment, the record-generation module generates or updates one or more structured product specification records in the product data repository by associating the retrieved asset metadata with the functional category corresponding to the resolved region.

In this embodiment, the complete pipeline—from 2D representation ingestion through region identification, category resolution, asset metadata retrieval, and repository record generation—executes without requiring any manual selection, drag-and-drop interaction, or other pointer-based input from a user. The resulting structured product specification data is equivalent in structure and repository format to data generated by a manually initiated assignment event.

In certain embodiments, the automated pipeline may operate in a proposed or assisted mode rather than a fully autonomous mode. In such embodiments, the image-analysis module identifies candidate regions and proposes a set of associations to a user for review and confirmation before repository records are generated. This allows the system to accelerate the assignment workflow while retaining user control over the resulting structured product specification data.

Accordingly, the mapping engine may process assignment events originating from a graphical user interface, an automated API call, a local computing process, or a remote computing process.

What is claimed is:

1: A computer-implemented system for generating structured product specification data, the system comprising:
a processor; and
a memory storing instructions executable by the processor to cause the system to:
maintain, in a data store, a mapping between each of a plurality of addressable regions of a two-dimensional (2D) product representation and a corresponding functional product category;
receive an assignment event that identifies a target addressable region of the plurality of addressable regions and a selected asset;
identify, based on the mapping, the functional product category corresponding to the target addressable region; and
generate or update a structured product specification record in a product data repository by associating metadata of the selected asset with the identified functional product category.

2: A computer-implemented method for generating structured product specification data, the method comprising:
maintaining, in a data store, a mapping between each of a plurality of addressable regions of a two-dimensional (2D) product representation and a corresponding functional product category;
receiving an assignment event that identifies a target addressable region of the plurality of addressable regions and a selected asset;
identifying, based on the mapping, the functional product category corresponding to the target addressable region; and
generating or updating a structured product specification record in a product data repository by associating metadata of the selected asset with the identified functional product category.

3: A non-transitory computer-readable medium storing instructions that, when executed by one or more processors, cause the one or more processors to perform operations comprising:
maintaining, in a data store, a mapping between each of a plurality of addressable regions of a two-dimensional (2D) product representation and a corresponding functional product category;
receiving an assignment event that identifies a target addressable region of the plurality of addressable regions and a selected asset;
identifying, based on the mapping, the functional product category corresponding to the target addressable region; and
generating or updating a structured product specification record in a product data repository by associating metadata of the selected asset with the identified functional product category.

4: A computer-implemented system for maintaining synchronization between a two-dimensional product representation and structured product specification data, the system comprising:
a processor; and
a memory storing instructions executable by the processor to cause the system to:
maintain a data mapping between a plurality of addressable regions of a two-dimensional (2D) product representation and corresponding structured product specification data stored in a product data repository;
propagate a first change from the 2D product representation to the product data repository by updating the structured product specification data in response to an assignment event associated with at least one addressable region; and
propagate a second change from the product data repository to the 2D product representation by updating at least one visual attribute of at least one addressable region in response to a change to the structured product specification data.

5: A computer-implemented method for maintaining synchronization between a two-dimensional product representation and structured product specification data, the method comprising:
maintaining a data mapping between a plurality of addressable regions of a two-dimensional (2D) product representation and corresponding structured product specification data stored in a product data repository;
propagating a first change from the 2D product representation to the product data repository by updating the structured product specification data in response to an assignment event associated with at least one addressable region; and
propagating a second change from the product data repository to the 2D product representation by updating at least one visual attribute of at least one addressable region in response to a change to the structured product specification data.

6: A non-transitory computer-readable medium storing instructions that, when executed by one or more processors, cause the one or more processors to perform operations comprising:
maintaining a data mapping between a plurality of addressable regions of a two-dimensional (2D) product representation and corresponding structured product specification data stored in a product data repository;
propagating a first change from the 2D product representation to the product data repository by updating the structured product specification data in response to an assignment event associated with at least one addressable region; and
propagating a second change from the product data repository to the 2D product representation by updating at least one visual attribute of at least one addressable region in response to a change to the structured product specification data.

7: A computer-implemented system for automated generation of structured product specification data, the system comprising:
a processor; and
a memory storing instructions executable by the processor to cause the system to:
access a two-dimensional (2D) product representation comprising a plurality of addressable regions, wherein each addressable region is associated with a functional product category in a stored mapping;
analyze the 2D product representation using an image-analysis module to automatically identify at least one target addressable region based on one or more visual characteristics of the 2D product representation, without requiring pointer-based user interaction;
determine a selected asset corresponding to the at least one target addressable region; and
generate or update structured product specification data in a product data repository by associating metadata of the selected asset with the functional product category corresponding to the at least one target addressable region.

8: A computer-implemented method for automated generation of structured product specification data, the method comprising:
accessing a two-dimensional (2D) product representation comprising a plurality of addressable regions, wherein each addressable region is associated with a functional product category in a stored mapping;
analyzing the 2D product representation using an image-analysis module to automatically identify at least one target addressable region based on one or more visual characteristics of the 2D product representation, without requiring pointer-based user interaction;
determining a selected asset corresponding to the at least one target addressable region; and
generating or updating structured product specification data in a product data repository by associating metadata of the selected asset with the functional product category corresponding to the at least one target addressable region.

9: A non-transitory computer-readable medium storing instructions that, when executed by one or more processors, cause the one or more processors to perform operations comprising:
accessing a two-dimensional (2D) product representation comprising a plurality of addressable regions, wherein each addressable region is associated with a functional product category in a stored mapping;
analyzing the 2D product representation using an image-analysis module to automatically identify at least one target addressable region based on one or more visual characteristics of the 2D product representation, without requiring pointer-based user interaction;
determining a selected asset corresponding to the at least one target addressable region; and
generating or updating structured product specification data in a product data repository by associating metadata of the selected asset with the identified functional product category.
